(19) United States
(12) Patent Application Publication
(10) Pub. No.: US 2010/0214782 A1
(43) Pub. Date: Aug. 26, 2010

(54) PROJECTOR FOR ILLUMINATING SURFACES AND GENERATING LIGHT EFFECTS

(75) Inventor: Fabio Allegri, Castel Goffredo (IT)

Correspondence Address: Pearne & Gordon LLP, 1801 East 9th Street, Suite 1200, Cleveland, OH, 44114-3108, US

(73) Assignee: COEMAR S.P.A., I-46042 Castel Goffredo (IT)

(21) Appl. No.: 12/738,107

(22) PCT Filed: Jan. 30, 2008
(86) PCT No.: PCT/IB08/50331

§ 371 Date: Apr. 15, 2010

(30) Foreign Application Priority Data
Oct. 16, 2007 (IT) PR2007A000078

(51) Int. Cl. F21S 10/00

(52) U.S. Cl. 362/249.07

(57) ABSTRACT

A projector (1) for lighting surfaces and creating light effects comprises a plurality of lighting bodies (3), each able to generate a light beam in a direction of projection, and means for actuating the lighting bodies (3) to vary the orientation of the corresponding light beams as well as light sources (4) able to generate colour or to be filtered. Known projectors for lighting architectural details or surfaces in the entertainment sector do not allow to vary and adjust the projected light beam at will.

### TECHNICAL FIELD AND BACKGROUND ART

The present invention relates to a projector for illuminating surfaces and generating light effects.

The invention refers to the sector of lighting engineering and in particular of projectors for lighting architectural details, or of projectors used in the theatre or in the field of entertainment and in all cases in which a precise light coverage of a surface and the generation of scenic effects.

In the sector of lighting engineering, in particular with regard to projectors with LED technology, there are apparatuses in which the body containing the light source, coloured or white, is fixed or moves as a single body.

In these technical solutions, the amplitude of the beam in some cases is controllable, modifying the distance of appropriate lenses from the light source or replacing optical assemblies. However, such solutions present some limitations in the possibility to control and adjust the amplitude and direction of the light beam generated by the projector.

For example, in known projectors with LED technology it is not possible to vary the amplitude of the light beam except by manually changing the lens assembly. Fixed or movable-head LED projectors exists, in which it is possible to orient the light beam on the two axes, but, in such cases, it is not possible to modify the amplitude of the light beam dynamically, with the possibility also of simultaneously illuminating distinct portions of a surface.

### DISCLOSURE OF THE INVENTION

The object of the present invention is to eliminate the aforesaid drawbacks and to make available a projector that is able to move, colour, modify or fraction the illuminate surface portion, with the possibility to adapt precisely the lighting conditions to architectural details with a single apparatus.

Said object is fully achieved by the projector of the present invention, which is characterised by the content of the appended claims and in particular in that it comprises, in combination:
a plurality of lighting bodies, each being able to generate a light beam in a direction of projection;
actuating means, operatively active on each lighting body to vary the orientation of the corresponding light beam, said actuating means co-operating to define on said surfaces areas of projection of desired shape.

Preferably, the lighting bodies are movable between a first position, in which the respective light beams are convergent, and a second position, in which the light beams are divergent, each lighting body being movable independently from the others.

In this way, it is possible independently to orient the light beams, and globally to obtain light beams that are very broad or extremely narrow, but in any case can be oriented and directed, e.g. precisely to adapt the light beams to architectural details.

### BRIEF DESCRIPTION OF DRAWINGS

These and other features shall become more readily apparent from the description that follows of a preferred embodiment, illustrated purely by way of non limiting example in the accompanying drawing tables, in which:

FIG. 1 shows a projector according to the present invention;

FIG. 2 shows the projector of FIG. 1, in a different operative position;

FIGS. 3-6 show possible applications of the projector of FIG. 1, in different operative configurations;

FIGS. 7-11 show possible applications of an embodiment variant of the projector of FIG. 1, in different operative configurations;

FIG. 12 shows a perspective view of the projector of FIG. 1, according to a different embodiment;

FIG. 13 shows a lateral view of the projector of FIG. 12;

FIG. 14 shows a top view of the projector of FIG. 12;

FIG. 15 shows the projector of FIG. 12, in a different operative position;

FIG. 16 shows the projector of FIG. 12, in an additional operative position.

### BEST MODE FOR CARRYING OUT THE INVENTION

In the figures, the reference number 1 designates a projector according to the present invention.

The projector 1 is a projector for lighting surfaces; the fields of application range from the illumination of architectural details, to the theatre or entertainment field in general and in all cases in which a precise light coverage is required.

The projector 1 comprises a frame 2 whereto is coupled a plurality of lighting bodies 3. In the illustrated examples, the projector 1 comprises three lighting bodies 3, but the lighting bodies 3 can also be present in a different number, provided it is greater than two.

Originally, each lighting body 3 is movable relative to the frame 1. Moreover, each lighting body 3 preferably comprises a plurality of light sources 4.

The light sources 4 are preferably a LED; alternatively, they can be, for example, halogen light sources. In general, the light sources are low voltage.

It should be noted that each lighting body 3 generates a light beam in a direction of projection. The light sources 4 that comprise a same lighting body 3 are oriented in a consistent manner.

Moreover, the projector 1 originally comprises means for actuating the lighting bodies 3, to vary the orientation of the corresponding light beams.

Said lighting means comprise, for example, a system of gears 5 (partially shown in the figures, but known in itself) that, in combination with mechanical controls, enable to rotate the lighting bodies 3 relative to the frame 2 manually.

Or, alternatively to the mechanical controls, the actuating means provide for the use of electric motors, which enable to rotate the lighting bodies 3 relative to the frame 2 automatically.

More specifically, each lighting body 3 is swivelling and it can be coupled individually or in a group to stepped or direct current motors controlled by an on board chip that enables its precise angular orientation, or it can be adjusted manually by means of mechanical controls coupled to the lighting bodies 3 themselves.

The possibilities to actuate the light beams of the lighting bodies 3 are substantially of two kinds, i.e. mechanical manual or with automatic control.

In the manual control system, the projection, whilst exploiting all the capabilities of the relative adjustment of the orientation of the different light beams, takes on a static nature.

It is possible to adjust the direction of the light beam manually through the use of pawls, screws or levers (not shown in the figures because they are known in themselves) that enable to move the lighting bodies 3.

This type of adjustment is preferably carried out at the start of the installation of the projector and it does not need additional interventions except to maintain the projector or move it to another location.

Each lighting body 3 can be moved and directed independently of the others.

On the other hand, the possibility of having an automatic control of the movements of the lighting bodies 3 enables to have an animation in the projection, with the possibility of dynamic variation of the illuminated portion of surface (for example according to a predefined program) and light changes and effects. In this condition, there are better opportunities to give dynamism and creativity to the projection.

The automatic control takes place thanks to the use of high precision motors (of the stepped type) controlled via software by an electronic board.

The software the manages the automatic actuation of the lighting bodies 3 can advantageously be modified and updated without acting on the hardware; this enables to intervene flexibly when there are new implementations, improvements of the operation or to create software dedicated to specific needs.

It is also possible to control the operation remotely through dedicated controllers or computers and alternatively to use, for example, an infrared remote control or the like without using connecting cables.

In this case, too, the movements of each lighting body 3 are mutually independent and separate.

With regard to the conformation of the lighting bodies 3 and the arrangement of the light sources 4 within the lighting bodies 3 themselves, two different embodiments are provided.

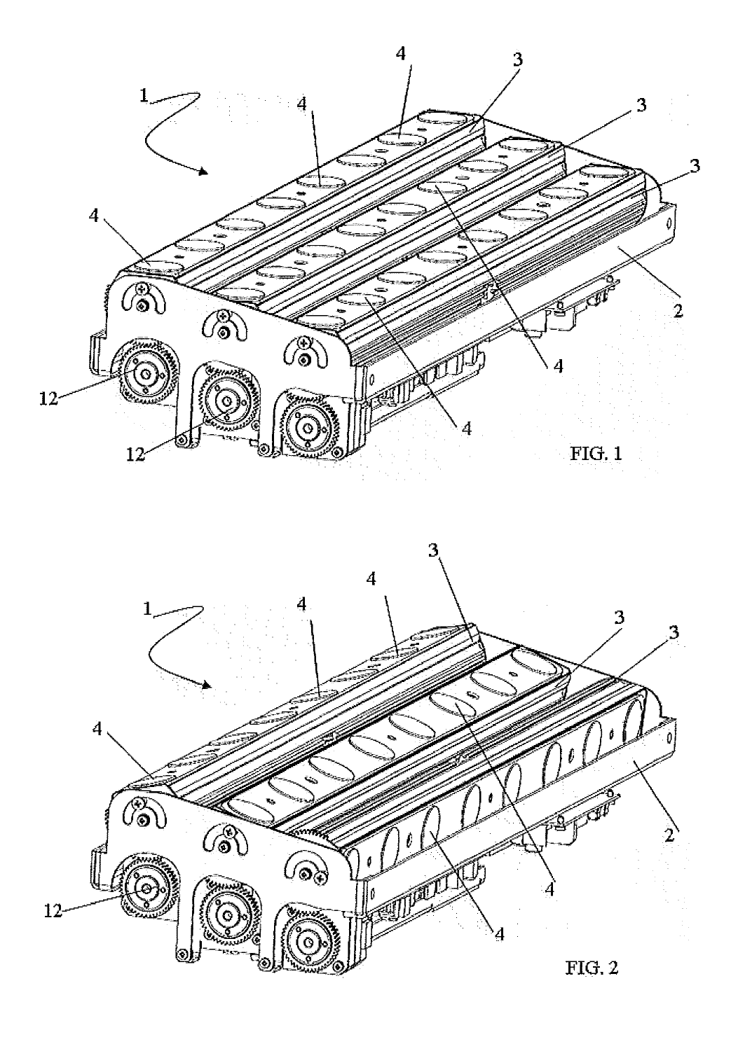

A first embodiment (shown in FIGS. 1 and 2) comprises the following arrangement.

The lighting bodies 3 are constituted by longitudinal supports positioned parallel in a longitudinal direction. The light sources 4 are positioned within each lighting body 3 along a row, aligned along a longitudinal axis; in this way, the light sources 4 of the different lighting bodies 3 are positioned on parallel rows.

In this case, the lighting bodies are movable preferably by rotation around the corresponding longitudinal axes.

A second embodiment comprises the following arrangement.

The lighting bodies 3 are constituted by sectors coupled to the frame 2 in such a way as to be arranged along a circumference. In particular, there are three lighting bodies 3, arranged at the vertices of an equilateral triangle.

Note that, in the second embodiment, each lighting body 3 is preferably movable in such a way that the projection axis describes a cone. In this way, it is also possible to illuminate simultaneously a plurality of separate surfaces and cause the projection defined by said surfaces moves in co-ordinated fashion, for example according to a circular trajectory (as schematically shown in FIG. 11).

In particular, the lighting bodies 3 are movable in such a way that the respective light beams converge or diverge.

Each light source 4 is positioned at the end of a respective arm 5 hinged on a shaft 6 of a corresponding motor 7 with digital control.

In this way, moving said arms 5 varies the inclination of the light beams relative to a reference plane defined by a flange 8 whereto are associated the motors 7.

Note that two or more light sources 4 motorised in this way are arranged circularly, also on multiple concentric lines, in such a way that the axes of the motors are tangential to a circumference parallel to the flange 8. Therefore, a rotation of one of said motors 7 enables the inclination relative to the horizontal plane of the light beam produced by the light source 4 connected to the motor itself.

Activating all the motors 7 simultaneously, a “corolla” type of opening and closing motion of the arms 5 with consequent broadening or narrowing of the projection angle (and hence of the amplitude of the light beam constituted by the composition of the beams of the individual lighting bodies 3).

In any case, note that in the preferred embodiment illustrated, each motor 7 is controlled independently.

Anyway, note that, if the independent movement of the lighting bodies is not required, a single motor 7 can advantageously be used to actuate all the arms 5.

The projection assembly constituted by the flange 8, by the motors 7 with the respective shafts 6, by the arms 5 and by the lighting bodies 3, is able to rotate relative to the frame 2.

Said projection assembly is set in rotary motion around an axis perpendicular to said reference plane (i.e. perpendicular to the plane where the motors 7 are positioned) through a gear formed by a is gearwheel 9 and a pinion 10 connected to an additional motor 11.

Note that the motors 7 can be controlled independently from each other or in unison by means of an electronic board incorporated in the projector 1. Said control can take place automatically, since a great number of sequences (or predetermined control programs) can be stored in the board, or receiving a special digital signal originating from an appropriate unit or computer in such a way as to allow the utmost manual or automatic control freedom.

Note also that each lighting body 3 is provided with means for enlarging or narrowing the light beam produced thereby.

Preferably, the light sources are combined with several optical assemblies to control yet more precisely the amplitude of the projection, possibly also in association with lens screen systems and/or filters of any kind.

Moreover, the projector 1 also comprises means for coupling the lighting bodies 3 (not shown in the figures because they are known in themselves), such that a displacement of one of the lighting bodies 3 is associated to corresponding displacements of the other lighting bodies 3. In the case of the first embodiment, the coupling means consist of a kinematic connection of the lighting bodies 3, for example by means of a system of gears 12.

In the case of the second embodiment, the coupling means are implemented in the control board of the electric motors that actuate the lighting bodies 3.

Therefore, the coupling means are interacting with the actuating means to vary in co-ordinated fashion the orientation of the light beams generated by the corresponding lighting bodies 3.

In any case, the coupling means can be deactivated, so that each lighting body 3 can be actuated independently from the others.

In this light, in the second embodiment the projector 1 comprises a plurality of electric motors, each coupled to a corresponding lighting body, to vary the orientation of the corresponding light beams automatically and independently or to obtain the same convergent/divergent coupling by means of a single motor coupled to an ad hoc mechanical system.

The present invention advantageously enables to illuminate a surface by varying the illuminated surface at will or to generate optical effects.

In particular, the projector of the invention enables to enlarge or narrow the illuminated surface, symmetrically or also not symmetrically relative to an axis of projection, to displace the illuminated surface and to obtain a plurality of mutually distinct illuminated surfaces.

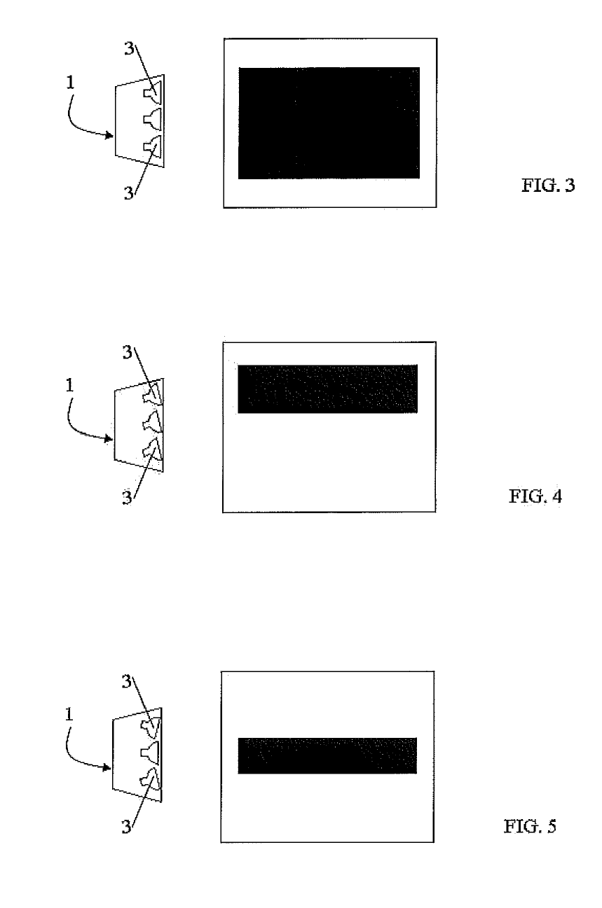

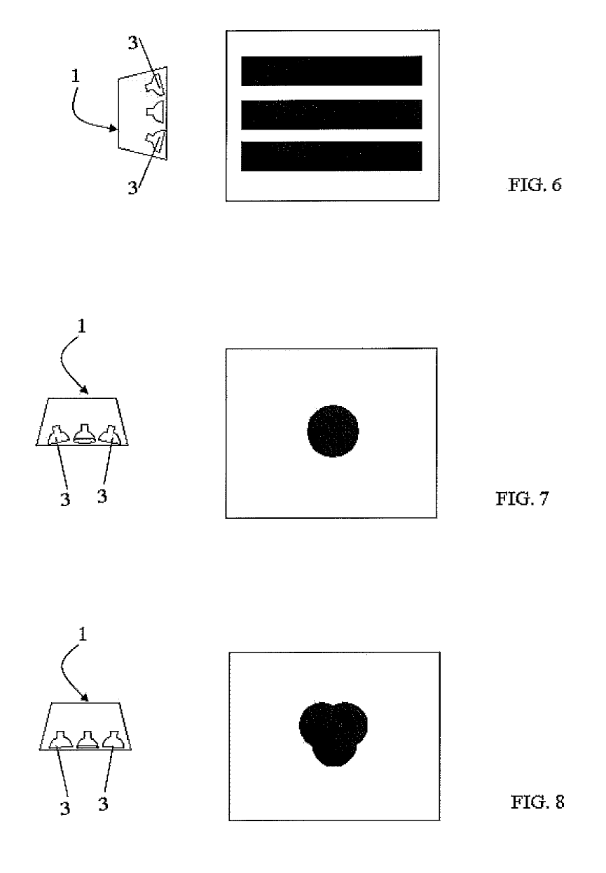

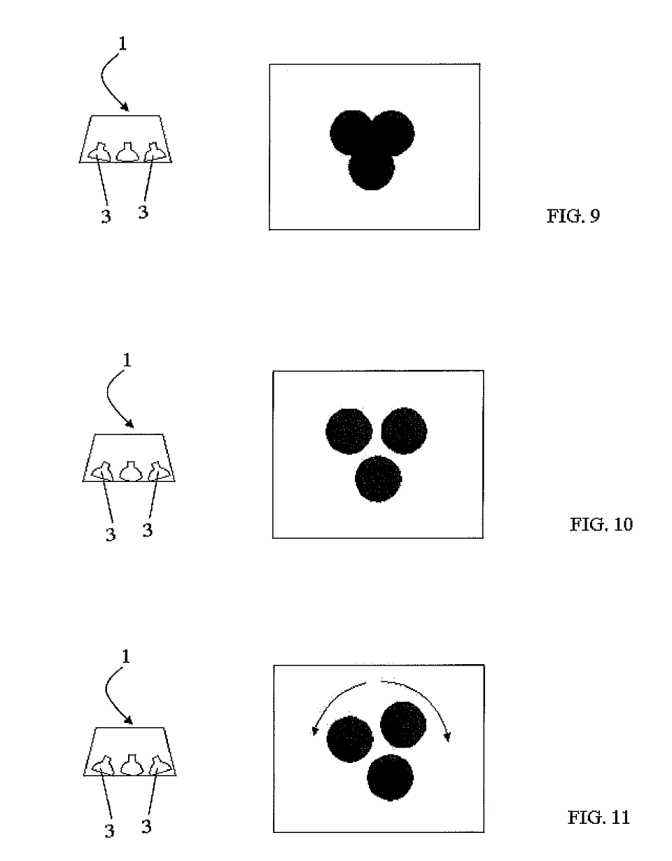

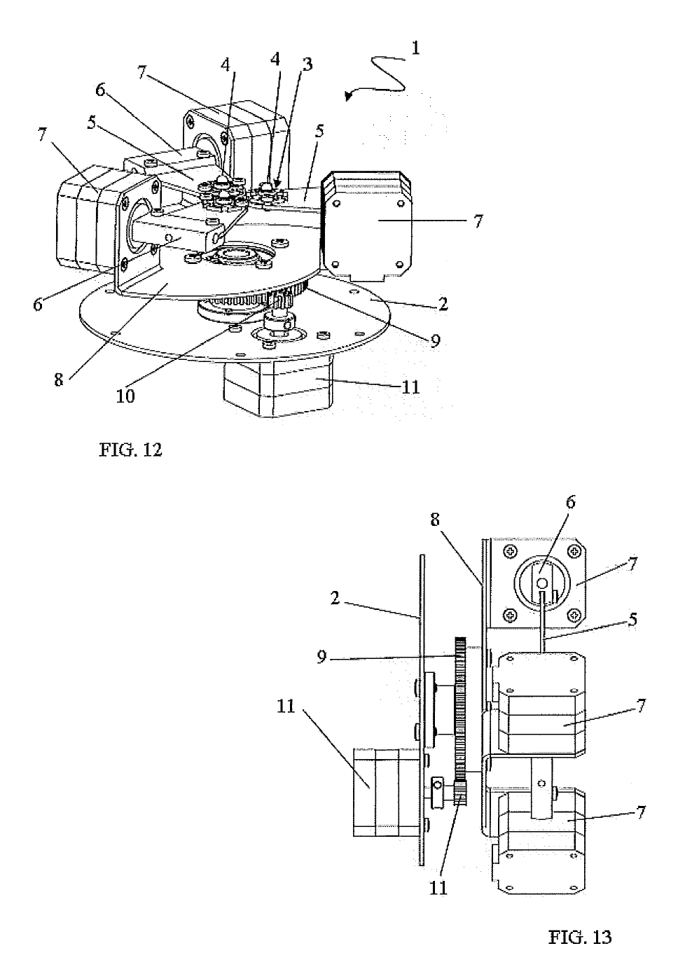

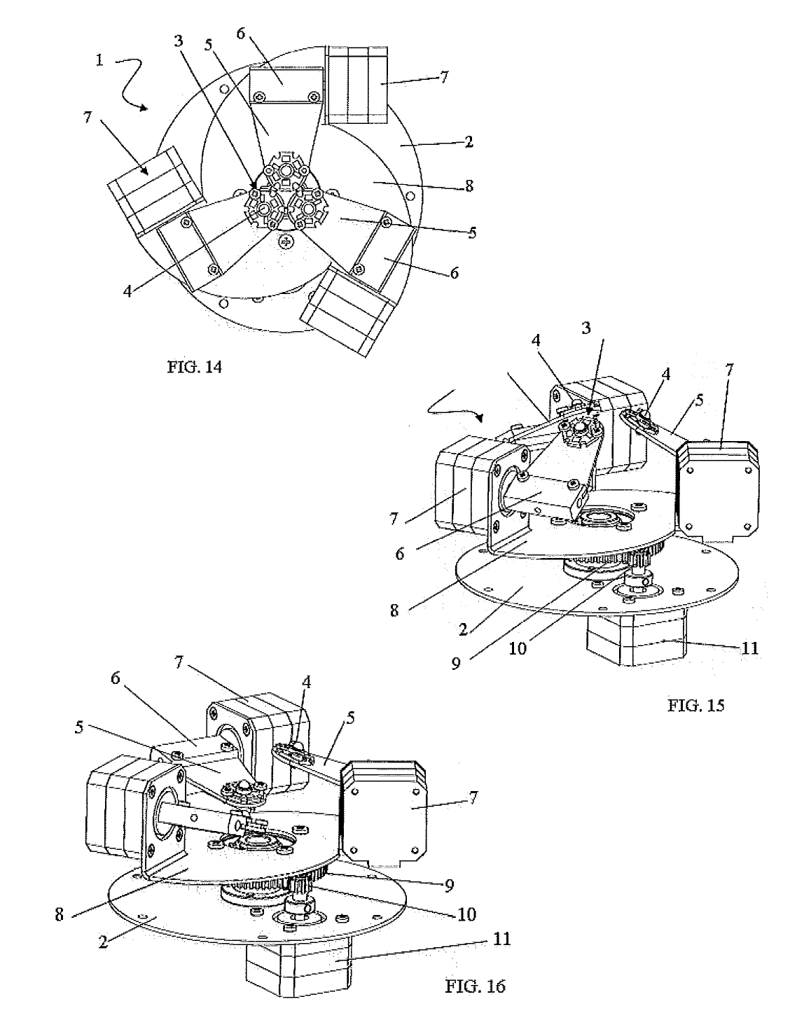

In this way, multiple lighting effects can be obtained, as exemplified in FIGS. 3-11.

The present invention enables to obtain these advantages originally, thanks to the generation of a plurality of light beams that can be modified and oriented in co-ordinated fashion, thereby enabling to combine them at will.

1. A projector (1) for illuminating surfaces and generating light effects,
characterised in that it comprises, in combination:
a plurality of lighting bodies (3), each being able to generate a light beam in a direction of projection;
actuating means, operatively active on each lighting body (3) to vary the orientation of the corresponding light beam, said actuating means co-operating to define on said surfaces projection areas of desired shape.

2. A projector as claimed in claim 1, wherein the lighting bodies are movable between a first position, in which the respective light beams are convergent, and a second position, in which the light beams are divergent, each illuminating body being movable independently from the others.

3. A projector as claimed in claim 1 or 2, wherein each lighting body (3) comprises a plurality of light sources (4).

4. A projector as claimed in claim 3, wherein each lighting body (3) comprises a plurality of light sources (4) aligned on a row and it is rotating around a longitudinal axis defined by said row.

5. A projector as claimed in claim 4, wherein the lighting bodies (3) are arranged such that the respective rows of light sources (4) are parallel to each other.

6. A projector as claimed in claim 3, wherein the lighting bodies (3) are arranged on a plane and are movable in such a way that the respective light beams converge or diverge.

7. A projector as claimed in claim 6, wherein the lighting bodies (3) are arranged at the vertices of a polygon or along a circumference.

8. A projector as claimed in any of the previous claims, wherein the means for actuating the lighting bodies (3) comprise a plurality of electric motors, to vary the orientation of the corresponding light beams automatically.

9. A projector as claimed in any of the claims 1 through 7, wherein the means for actuating the lighting bodies (3) comprise a system of gears (12) connected to mechanical controls, to vary the orientation of the corresponding light beams manually.

10. A projector as claimed in any of the previous claims, comprising means for coupling the lighting bodies (3), interacting with the actuating means to vary the orientation of the corresponding light beams in a co-ordinated manner.

11. Projector as claimed in claim 10, wherein the coupling means can be deactivated, such that each lighting body (3) can be actuated independently of the others.

12. Projector as claimed in any of the previous claims, wherein the light sources are LEDs.
